(19) United States
(12) Patent Application Publication
(10) Pub. No.: US 2008/0162189 A1
(43) Pub. Date: Jul. 3, 2008

(54) Information Management System In Cosmetics Sales

(75) Inventors: Akihide Hamano, Tokyo (JP); Tomoko Fukuyama, Tokyo (JP); Masayuki Shimazu, Tokyo (JP)

Correspondence Address: DARBY & DARBY P.C., P.O. BOX 770, Church Street Station, New York, NY, 10008-0770, US

(73) Assignee: SHISEIDO COMPANY, LTD., Tokyo (JP)

(21) Appl. No.: 11/814,396

(22) PCT Filed: Jan. 20, 2006
(86) PCT No.: PCT/JP06/00837

§ 371 Date: Jul. 20, 2007

(30) Foreign Application Priority Data
Jan. 21, 2005 (JP) 2005-013485

(51) Int. Cl. G06Q 10/00

(52) U.S. Cl. 705/3

(57) ABSTRACT

To enable a retail store that sells cosmetics to grasp the situations of its own customers who are cosmetics users precisely. An information management system includes a center side system, a plurality of store side systems and a plurality of member terminals both connected with the center side system, wherein the store side system has a function for collecting member information and a function for sending the collected information to the center side system, and the center side system has a function for storing the received information, and a function for extracting necessary information based on the request from the store side system or the member terminal.

### CROSS REFERENCE TO RELATED APPLICATIONS

This is a U.S. national phase application under 35 U.S.C. § 371 of International Patent Application No. PCT/JP2006/300837, filed Jan. 20, 2006, and claims the benefit of Japanese Application No. 2005-013485, filed Jan. 21, 2005. The International Application was published in Japanese on Jul. 27, 2006 as International Publication No. WO 2006/077959 under PCT Article 21(2). The content of both applications is incorporated herein in its entirety.

### TECHNICAL FIELD

The present invention relates to an information management system enabling a commodity supplier such as a cosmetics manufacturer to assist a retail store that deals in cosmetics in sales, and provide information to a cosmetics user.

### BACKGROUND ART

Conventionally, a retail store that sells cosmetics has managed information on customers to offer various services to its own customers. The information on customers includes a personal basic attribute such as the address, name, age and gender of a customer, as well as purchase histories of cosmetics. In addition, medical records diagnosing the customer's skin conditions or the like are also managed together with information on the customer.

Each store sends out direct mail or advises a customer about cosmetics suited for the customer when the customer comes to the store, based on information on the customer managed by each store.

Meanwhile, cosmetics manufacturers sometimes provide services, in which a user of their own cosmetics is provided with points according to the amounts of purchase by the user, and is offered benefits such as free gifts according to the accumulated number of points. Such points are managed by each store, and each store makes a request of free gifts to the manufacturers according to the points of the customer of its own store.

Note that no particular patent search was conducted regarding this background art, as this is usually carried out in retail stores that sell cosmetics.

When the purchase histories and skin conditions of customers are managed by each store, as described above, there are the following inconveniences.

First, when one user purchases cosmetics at a plurality of stores, it is difficult for each store to grasp the usage of cosmetics from his/her purchase history because his/her purchase history is managed by each store. For example, since a store does not know what commodities the user purchased at other stores from the purchase history managed by the store, the store cannot grasp what cosmetics the user actually uses; therefore, there is a problem that the store cannot give pointed advice about recommended cosmetics, consumption, a care method or the like.

Further, there is also a problem that, when points are provided as a service of a manufacturer, the amounts of purchases are added up by each store and this amount is converted into points, such that even if products from the same manufacturer are purchased, the total amount of the purchases is not precisely reflected in the points.

In addition, cosmetics providers such as manufacturers cannot grasp precisely information such as sales volume, which tells how their own products, which were sold to retail stores, were actually sold.

An object of the present invention is to enable a retail store that sells cosmetics to grasp precisely the situations of its own customers, who are cosmetics users, and to grasp precisely the usage of the cosmetics of the customers, for example, to provide a pointed advice.

Further, another object of the present invention is to provide an information management system enabling services to be offered beyond the borders of individual stores.

### SUMMARY OF THE INVENTION

A first embodiment is based on a system having a center side system, a plurality of store side systems connected to the center side system through communication means and a plurality of member terminals connected to the center side system through communication means, and has the following characteristic points:

Then, the store side system has a function for collecting member information such as a personal attribute associated with a member ID, sales information regarding a sales commodity, a sales price and a sales time associated with both a member ID and a store ID, or only with a store ID, and skin diagnosis information comprised of skin data and the time of skin diagnosis associated with the member ID, and a function for sending the member information, the sales information and the skin diagnosis information to the center side system.

In addition, the center side system has a function for storing the member information, the sales information and skin diagnosis information, which are received from the store side system, a function, when a request to obtain member information, sales information or skin diagnosis information associated with a store ID is received from the store side system, for identifying the sales information associated with the store ID of this store, while at the same time, based on the identified sales information, extracting the member information, the sales information or the skin diagnosis information associated with the member ID and sending these to the store side system associated with the store ID, a function, when a request to obtain sales information or skin diagnosis information is received from the store side system specifying a member ID, for extracting a sales history or skin diagnosis information associated with the member ID and sending this to the store side system, and a function, when a request to obtain a purchase history or skin data associated with a member ID is received from a member terminal, for extracting the sales information or the skin diagnosis information associated with the member ID and sending this to the member terminal associated with the member ID.

A second embodiment is based on the first embodiment, and is characterized that the center side system has a function for conducting business analysis based on the member information and the sales information, and a function for sending the result of the analysis to the store side terminal.

A third embodiment is based on the second embodiment, and is characterized by comprising a commodity supplier side terminal connectable to the center side system, wherein the commodity supplier side terminal has a function for causing the center side system to conduct the business analysis.

A fourth embodiment is based on a system including a center side system, a plurality of store side systems connected to the center side system through communication means and a plurality of member terminals connected to the center side system through communication means, and has the following characteristic points:

Then, the store side system includes information collecting means and sending/receiving means for sending the collected data to the center side system, and the center side system comprises center side sending/receiving means for exchanging information with the store side system, information storage means for storing the received member information, sales information and skin diagnosis information and processing means for performing information processing.

In addition, the information collecting means in the store side system has a function for collecting member information such as a personal attribute associated with a member ID, sales information regarding a sales commodity, a sales price and a sales time associated with both a member ID and a store ID, or only with a store ID, and skin diagnosis information comprised of skin data and the time of skin diagnosis associated with the member ID, and the processing means in the center side system has a function, when a request to obtain the member information, the sales information or the skin diagnosis information associated with the store ID is received from the store side system, for identifying the sales information associated with the store ID of this store, while at the same time, based on the identified sales information, extracting the member information, the sales information or the skin diagnosis information associated with the member ID, a function, when a request to obtain the sales information or skin diagnosis information is received from the store side system specifying a member ID, for extracting a sales history or the skin diagnosis information associated with the member ID, a function for sending the extracted information to the store side system, a function, when a request to obtain a purchase history or skin data associated with the member ID is received from the member terminal, for extracting the sales information or the skin diagnosis information associated with the member ID, and a function for sending the extracted information to the member terminal associated with the member ID.

According to the first to fourth embodiments, retail stores that sell cosmetics can gather precise information on purchase histories and skin conditions of their own customers.

Further, the retail stores can offer appropriate services beyond the borders of the stores.

As a result, the customers can get pointed advice about beauty and other services.

In addition, the stores that sell cosmetics can use a center side system to analyze their own sales information and information on customers.

### BRIEF DESCRIPTION OF THE DRAWINGS

FIG. 1 is an overall configuration diagram of a system of the present invention;

FIG. 2 is a table for simulating the number of members to be acquired relative to a sales target;

FIG. 3 is a table showing members' stratified sales; and

FIG. 4 is a table showing an example limiting the information accessible from each terminal.

### DETAILED DESCRIPTION OF THE INVENTION

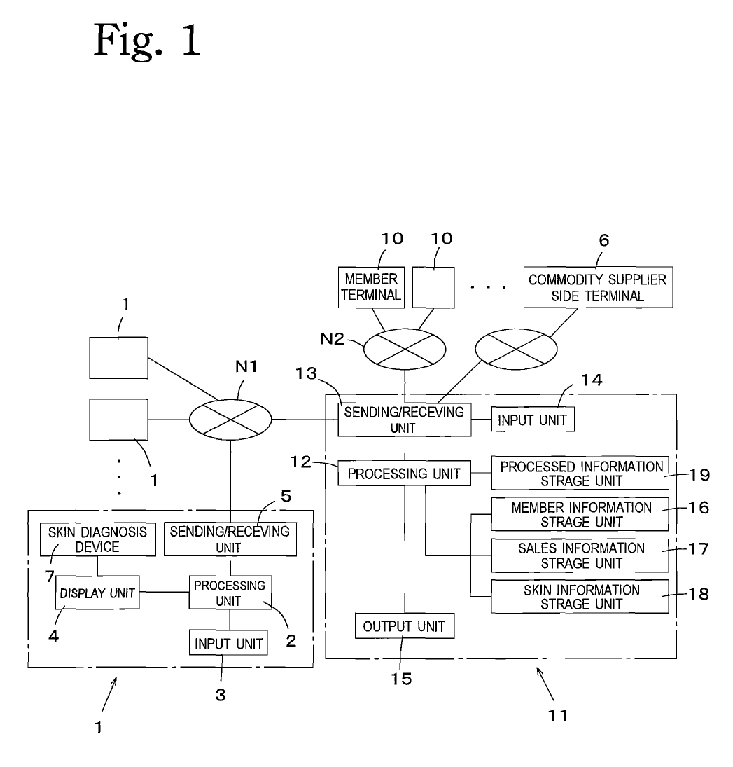

An embodiment of the present invention will be described with reference to FIGS. 1 to 4.

FIG. 1 shows the overall configuration of a system of the present invention, wherein a store side system 1 disposed in a store of a retail outlet that sells cosmetics is connectable to a center side system 11 through communication means N1 such as the Internet. The center side system 11 includes a server that is managed by an information manager. The information manager may be a supplier of cosmetics that each retail store deals in, such as a cosmetics manufacturer, or may be another third party.

Note that, in addition to makeup cosmetics and skin-care cosmetics including facial washes and makeup removers, cosmetics in the present invention includes shampoos, hair conditioners, hair restoration tonics, supplements, drugs and quasi drugs or the like.

Further, to the center side system 11, a plurality of member terminals 10 are connectable through communication means N2 such as the Internet, and a commodity supplier side terminal 6 is also connectable through communication means N3. Note that the communication means N1, N2 and N3 may be the same communication means or separate communication means.

The member terminal 10 includes a personal computer or the like used by a registered member customer. In the system of the present embodiment, the store side system 1 and the member terminal 10 are always communicated through the center side system 11.

The commodity supplier side terminal 6 is a terminal used by a person in charge on the side of a commodity supplier such as a manufacturer and a wholesaler. In this system, the commodity supplier side terminal 6 can access information in the center side system 11 through the communication means N3.

The store side system 1 comprises a processing unit 2 for performing operations, an input unit 3 linked to the processing unit, a display unit 4 such as a display and a sending/receiving unit 5 for sending/receiving data to/from the center side system 11. The input unit 3 includes a keyboard, a card reader for reading information on a membership card, and a point of sales (POS) terminal for capturing sales information.

Further, a skin diagnosis device 7 is connected to the processing unit 2.

The store side system 1 may be constituted by a totally integrated device or a plurality of devices.

Meanwhile, the center side system 11 has a processing unit 12 for performing data processing, a sending/receiving unit 13, which is linked to the processing unit 12 and communicates with the store side system 1, the member terminal 10 and the commodity supplier side terminal 6, an input unit 14 and an output unit 15 such as a display. Further, the center side system 11 also has a member information storage unit 16, a sales information storage unit 17 and a skin information storage unit 18, which store data collected by each store side system 1, and a processed information storage unit 19 for storing processed data.

Note that the center side system 11 may be constituted by one server, or the system may be constituted by distributing each function to separate devices.

Next, information stored in each storage unit 16 to 19 in the center side system 11 will be described.

Member information stored in the member information storage unit 16 is attribute information of members associated with member IDs, which is collected by performing membership registration of cosmetics users with the store side system 1.

As the procedure of the membership registration, a person in charge in each store enters through the input unit 3 into the processing unit 2, personal attribute information of a member-to-be user such as the name and age, and the member ID to be assigned to the member. The processing unit 2 associates the entered personal attribute information with the member ID to be member information of a new member, and sends the information to the center side system 11 through the sending/receiving unit 5.

The processing unit 12 in the center side system 11 stores the received member information of the new member in the member information storage unit 16.

In this manner, the member information is stored in the membership storage unit 16, and the membership registration is completed. Note that the assignment of member IDs may be performed by any method. However, since the code must be unique to each member information from all the members managed by the center, methods can be considered of assigning member IDs to each store in advance, or assigning a member ID that is randomly specified when the processing unit 12 in the center side system 11 receives the personal attribute information of the new member.

Sales information, which is stored in the sales information storage unit 17, is data collected by the input unit 3 of each store side system 1, and is information associating a sales commodity, a sales price and a sales time with a member ID and a store ID.

The input unit 3 has a function for reading a commodity code from a bar code or the like on the commodity and sending the commodity code and sales data such as a sales price to the processing unit 2 at the time of selling the commodity, while at the same time, reading the member ID of a member who is the purchaser of the commodity from the membership card and sending the member ID to the processing unit 2. The processing unit 2 associates the sales data with the member ID, which are entered from the input unit 3, and sends it to the center side system 11 as sales information.

However, if the purchaser is not a member, in the store, the commodity code and the sales data such as the sales price are entered from the input unit 3 and the processing unit 2 sends it to the center side system 11. In the center side system 11, the processing unit 12 determines whether or not there is a member ID in the received data, and, if a member ID is not included, stores the data into the sales information storage unit 17 as non-member sales information.

Then, in the present embodiment, the input unit 3 and the processing unit 2 constitute the information collecting means of the present invention and realize the functions of collecting information.

In addition, skin information, which is stored in the skin information storage unit 18, is information associating skin data measured by the skin diagnosis device 7 in the store side system 1 with measuring time and a member ID. However, the skin data may be stored by associating the store ID of the store that conducted the diagnosis. By associating the store ID in this manner, it can be determined from the data stored in the skin information storage unit 18 at which store the skin data was measured.

Any type device may be used for the skin diagnosis device 7, including a device that is provided with a microscope, captures the image data of skin conditions, and measures the moisture and sebum of the skin, for example. Then, the member ID of a person being tested is associated with the measured result to be skin information, which, in turn, is sent to the center side system 11 through the sending/receiving unit 5.

Note that the processed information storage unit 19 stores information processed by the processing unit 12, and web site data required to generate a store web site accessible from each store side system 1, and a member web site accessible from the member terminal 10.

As described above, the member information, the sales information and the skin information collected by each store are collectively managed in a center. The center side system 11 includes a function for collectively managing the information collected by each store, and conducting business analysis based on the information. A program for business analysis is set in the processing unit 12.

Then, the business analysis may be conducted by the processing unit 12 through the input unit 14 in the center side system 11. In addition, the commodity supplier can use the terminal 6 and the store side system 1 to cause the processing unit 12 to conduct the analysis.

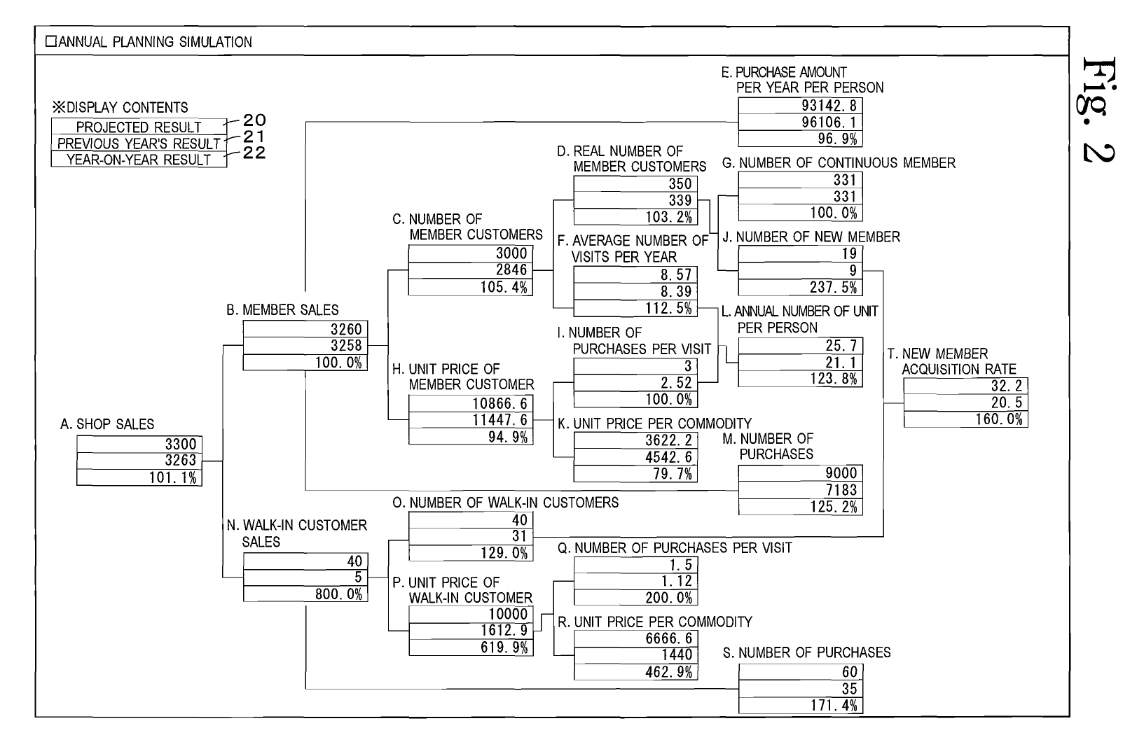

As business analysis, a table shown in FIG. 2 may be used to simulate member users to be acquired relative to a sales target per year, for example. Each frame shown in FIG. 2 has a projected result column 20, a previous year's result column 21 and a year-on-year result column 22; in the result column 21, the previous year's data is extracted from the sales information stored in the sales information storage unit 17 and summed by the processing unit 12, which is automatically applied to the result column 21 for display.

When data is displayed on the result column 21, required numeric values are entered into each projected result column 20 by referring to the data. However, it is not necessary to enter numeric values into all the projected result columns 20; there are also columns where automatically calculated values are displayed.

For example, if a sales target per year is entered into the projected result column 20 of shop sales A shown in FIG. 2, and the sales target for member sales B, which is the sales for members, is entered at the same time, a walk-in customer sales N, which is for non-members, is automatically calculated as the difference between the sales per year A and the member sales B, and automatically displayed on the projected result column 20 of walk-in customer sales N.

In this manner, data is entered into all the columns including automatically calculated columns, thus, the number of members required to achieve the sales target per year can be simulated.

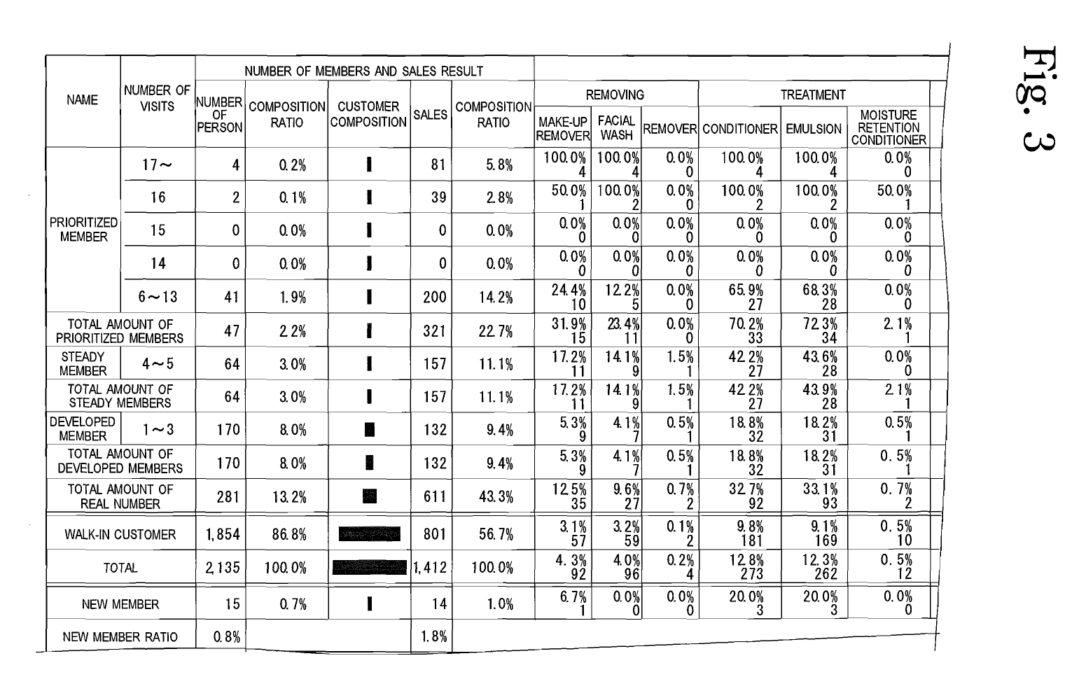

In addition, as shown in a table in FIG. 3, members can be divided according to ranks to perform stratified sales analysis. The rank of a member is determined based on the number of visits to the store. For example, prioritized members, steady members and developed members are established in order of the number of visits, and the prioritized members are further divided into a plurality of ranks. Note that the number of visits that delimits each rank may be set depending on the situation at each store.

Now that such analyses can be performed, the relationship between sales and the rank of a member is clear, such that planning of member acquisition by rank and planning of services to members by rank are easier to achieve.

The store side terminal 1 or the commodity supplier side terminal 6 accesses the center side system 11 to process such analysis.

Note that, if each analysis is performed by each store, the processing unit 12 identifies a store ID from the accessing store side terminal 1, and extracts the data associated with the store ID from the sales information in the sales information storage unit 17.

Further, in addition to the simulation and the analysis shown in FIGS. 2 and 3, the center side can add up total sales, display in time sequence the stratified sales results for acquired members, and analyze the total number of members and the member attributes or the like.

Moreover, the commodity suppliers such as manufacturers and wholesalers can grasp, regarding all the commodities, information about when, where, and how many were sold.

Since the center side system 11 manages the purchase history of each member, in addition to the above business analysis, the stores can improve the member service based on the purchase histories of the members. For example, the usage of cosmetics, such as that member's consumption of cosmetics, can be estimated more precisely from the purchase history. Conventionally, since histories of purchases only at the store itself was managed store by store, a store sometimes recommended the same commodity to a user even immediately after the user purchased specific cosmetics at another store. However, if each store can share information kept in the center side system 11, the member's consumption of cosmetics can be precisely estimated.

In addition, in regard to skin information, similarly, as the skin information collected by all the stores is managed associated with member IDs, the stores can also refer to diagnostic results at other stores.

Further, since the center side system 11 and the commodity suppliers collectively manage member information and sales information collected by a plurality of store side systems 1, the purchase histories of cosmetics for individual members can be precisely grasped regardless of the store where the member purchased the commodity.

For example, when a manufacturer, not a store, provides points according to the amounts of purchase, the number of points is also calculated by the processing unit 12 in the center side system 11, therefore, the total amounts of purchase are reflected in the points even if a member purchases commodities at another store.

Note that the center side system 11 creates and manages a store web site and a member web site. These web sites are a store web site accessible from the store side system 1 so that such analysis results as the above, and purchase histories and skin conditions of members who are customers, can be grasped store by store, and a member web site that is made accessible from the member terminal 10 so that each member obtains his/her own purchase history and skin information.

Further, the store side web site has a store homepage creation support site for creating a homepage for the store.

The store homepage creation support site is a site allowing a homepage to be created easily by applying to a page where basic layout and color are stylized for a store homepage, information from the center side and information unique to each store. Use of such a site allows anyone to easily create a store homepage with each store side system 1. Furthermore, by providing from the center side the basic layout and color of the homepage, the image of the homepages of all the stores can be made uniform with the intent of the center side such as manufacturers.

Although the store side terminal 1, the member terminal 10 and the commodity supplier side terminal 6 can use information managed by the center side system 11 in this manner, this is not meant to allow anyone to view all the information, but to allow limitations to be set. For example, leakage of personal information such as purchase histories and skin information that determine the attribute information of an individual is sometimes undesirable.

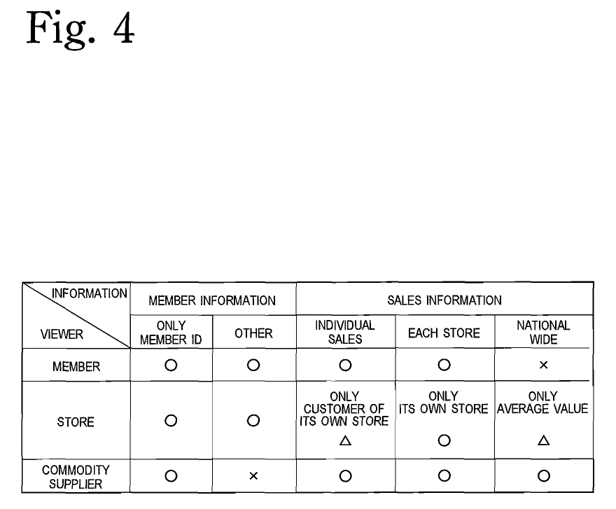

Hence, for example, as shown in FIG. 4, it is considered that information accessible, in other words, viewable from each terminal is limited.

A table in FIG. 4 indicates the type of viewers vertically, and the type of information horizontally, a circle “◯” indicating viewable, a cross “x” indicating not viewable, and a triangle “Δ” indicating partially viewable, in each associated column.

For example, individual members can view the member information and the sales information associated with his/her member ID. That is to say, the member can display on the member terminal 10 his/her own attribute information, purchase amounts and purchased commodities, as well as, limited only to stores where the customer made purchases, the aggregates of the purchase amounts store by store. However, the member cannot view the purchase information of the other members and the sales information about stores where the customer did not make purchases.

In addition, in principle, each store can view only information relating to its own store. Among the sales information, its own sales information can be viewed, at the same time, regarding its own customers, the purchase history member by member can also be viewed. Regarding sales information of other stores, information specifying individual stores cannot be viewed, however, national average sales and the like are made viewable.

In addition, the commodity supplier cannot view member information other than the member ID, however, the commodity supplier can view other member information and sales information. Accordingly, information by which an individual can be identified, such as name, cannot be viewed, however, sales information and skin diagnosis information can be viewed and added, with the member ID specified.

As described above, personal information can be protected by placing limitation on the type of information accessible from each terminal.

On the other hand, a member can log onto the member web site using his/her ID and password to display his/her member information, purchase history, skin information, and the number of acquired points according to sales. When the member terminal 10 specifies a member ID and accesses the center side system 11, the center side system 11 extracts corresponding information from each information storage units 16, 17, 18 and 19, based on the member ID, and displays the information.

In addition, on the member web site, registered member information, in other words, the attribute information of the member may be modified. In this manner, for example, a member can directly modify his/her attribute information without going to the store when the address and telephone number change.

In addition, since the skin information and member information of each member are stored in the center side system 11, the information can be used to create advice about beauty suitable for individual members in the center side system 11, and display the advice on the member web site.

Further, a page where a question or a request is entered and sent from can also be provided on the member web site, the center side system 11 receiving this and replying with answers to that question, or replying with advices based on the request.

The advice is selected by the processing unit 12 based on the skin information, purchase history, and request of the member out of advice data stored in advance in a storage unit, not shown.

Note that, in the above embodiment, the commodity supplier side terminal 6 used by the commodity supplier is connected to the center side system 11, however, if the commodity supplier manages the center side system, the commodity supplier can access information managed by the center side system 11 through the input unit 14 in the center side system 11, therefore, the commodity supplier side terminal 6 may not be provided.

1. An information management system in cosmetics sales comprising: a center side system, a plurality of store side systems connected to the center side system through communication means and a plurality of member terminals connected to the center side system through communication means, wherein the store side system has a function for collecting member information such as a personal attribute associated with a member ID, sales information regarding a sales commodity, a sales price and a sales time associated with both a member ID and a store ID, or only with a store ID, and skin diagnosis information comprised of skin data and the time of skin diagnosis associated with the member ID, and a function for sending the member information, the sales information and the skin diagnosis information to the center side system, and the center side system has a function for storing the member information, the sales information and skin diagnosis information, which are received from the store side system, a function, when a request to obtain member information, sales information or skin diagnosis information associated with a store ID is received from the store side system, for identifying the sales information associated with the store ID of this store, while at the same time, based on the identified sales information, extracting the member information, the sales information or the skin diagnosis information associated with the member ID and sending these to the store side system associated with the store ID, a function, when a request to obtain sales information or skin diagnosis information is received from the store side system specifying a member ID, for extracting a sales history or skin diagnosis information associated with the member ID and sending this to the store side system, and a function, when a request to obtain a purchase history or skin data associated with a member ID is received from a member terminal, for extracting the sales information or the skin diagnosis information associated with the member ID and sending this to the member terminal associated with the member ID.

2. The information management system in cosmetics sales according to claim 1 wherein the center side system has a function for conducting business analysis based on the member information and the sales information, and a function for sending the result of the analysis to the store side terminal.

3. The information management system in cosmetics sales according to claim 2 comprising a commodity supplier side terminal connectable to the center side system, wherein the commodity supplier side terminal has a function for causing the center side system to conduct the business analysis.

4. An information management system in cosmetics sales comprising: a center side system, a plurality of store side systems connected to the center side system through communication means and a plurality of member terminals connected to the center side system through communication means, wherein the store side system comprises information collecting means and sending/receiving means for sending the collected information to the center side system, and the center side system comprises center side sending/receiving means for exchanging information with the store side system, information storage means for storing the received member information, sales information and skin diagnosis information and processing means for performing information processing, the information collecting means in the store side system has a function for collecting member information such as a personal attribute associated with a member ID, sales information regarding a sales commodity, a sales price and a sales time associated with both a member ID and a store ID, or only with a store ID, and skin diagnosis information comprised of skin data and the time of skin diagnosis associated with the member ID, and the processing means in the center side system has a function, when a request to obtain member information, sales information or skin diagnosis information associated with a store ID is received from the store side system, for identifying the sales information associated with the store ID of this store, while at the same time, based on the identified sales information, extracting the member information, the sales information or the skin diagnosis information associated with the member ID, a function, when a request to obtain the sales information or skin diagnosis information is received from the store side system specifying a member ID, for extracting a sales history or skin diagnosis information associated with the member ID, a function for sending the extracted information to the store side system, a function, when a request to obtain a purchase history or skin data associated with the member ID is received from the member terminal, for extracting the sales information or the skin diagnosis information associated with the member ID, and a function for sending the extracted information to the member terminal associated with the member ID.
